(19) United States
(12) Patent Application Publication
(10) Pub. No.: US 2015/0062141 A1
(43) Pub. Date: Mar. 5, 2015

(54) ALERT DISPLAY DEVICE AND ALERT DISPLAY METHOD

(71) Applicant: TOYOTA JIDOSHA KABUSHIKI KAISHA, Toyota-shi Aichi-ken (JP)

(72) Inventor: Shoichi Hayasaka, Atsugi-shi Kanagawa (JP)

(21) Appl. No.: 14/475,017

(22) Filed: Sep. 2, 2014

(30) Foreign Application Priority Data
Sep. 4, 2013 (JP) 2013-183180

(51) Int. Cl. G09G 5/30; B60R 1/00; G09G 5/00

(52) U.S. Cl. CPC G09G 5/30; G09G 5/003; B60R 1/00; G09G 2380/10; G09G 2340/14; G09G 2320/10; B60R 2300/205; B60R 2300/301; B60R 2300/307; B60R 2300/8093
USPC 345/581

(57) ABSTRACT

Disclosed is an alert display device which highlights an object to be alerted in an actual view in front of a driver of a vehicle or around the vehicle. In alert display which highlights the object to be alerted in the actual view in front of the driver of the vehicle or around the vehicle, the object to be alerted in front of the vehicle or around the vehicle is detected, and display in which the edge of a display image to be displayed to highlight the object to be alerted in the actual view in front of the driver of the vehicle or around the vehicle is clear and display in which the edge is blurred are switched.

### BACKGROUND OF THE INVENTION

1. Field of the Invention

The present invention relates to an alert display device and an alert display method which highlight an object to be alerted in an actual view in front of a driver of a vehicle or around the vehicle.

2. Related Background Art

A variety of devices which support a driver have been developed, and of these devices, a device which provides information regarding an object to be alerted, such as a pedestrian, in front of the driver or around the driver is known. In order to inform the driver of the presence of the object to be alerted, a head-up display (HUD) which highlights the object to be alerted in the actual view in front of the driver or the like (for example, displays a frame surrounding the object or an underscore below the object in a superimposing manner) is provided. For example, Japanese Unexamined Patent Application Publication No. 2005-135037 discloses a vehicular information display device which displays an alarm regarding an obstacle in front of a vehicle on a head-up display (for example, displays a bright circular frame surrounding the obstacle) and when it is estimated that the driver recognizes the content of the alarm by comparing the eye direction of the driver and the display position of the alarm, changes the display method of the alarm (for example, decreases luminance, changes the display position, or stops the display).

Japanese Unexamined Patent Application Publication No. 2008-30729 is another example of the related art.

A line or a zone, such as a frame or an underscore, which is used for highlighting on the head-up display has an edge at both ends (both sides) thereof. The human eye is likely to focus on the edge of the frame. For this reason, if a frame or the like is displayed, the driver focuses on the edge of the frame or the like and keeps the eyes fixed to the edge (consequently, the frame or the like). The position where the frame or the like is displayed on the head-up display and the position where the object to be alerted is present are different, thus, as the difference between the distance from the driver to the display position and the distance to the object to be alerted is large, the driver spends time to focus on the object to be alerted, and is late in recognizing the object to be alerted. In Japanese Unexamined Patent Application Publication No. 2005-135037, although the display method of the alarm is changed, even if luminance is decreased, display with the edge remaining is continued, thus, the driver is likely to focus on the alarm which is displayed even after the display is changed.

Accordingly, an object of the invention is to provide an alert display device and an alert display method capable of suppressing delay of recognition of an object to be alerted itself by highlighting.

According to an aspect of the invention, there is provided an alert display device which highlights an object to be alerted in an actual view in front of a driver of a vehicle or around the vehicle, the device including a detection unit configured to detect the object to be alerted in front of the vehicle or around the vehicle, a control unit configured to perform display control of a display image for highlighting the object to be alerted detected by the detection unit, and a display unit configured to display the display image for highlighting the object to be alerted detected by the detection unit in the actual view in front of the driver of the vehicle or around the vehicle based on the display control by the control unit, in which the control unit performs switching control for switching between display in which the edge of the display image is clear and display in which the edge of the display image is blurred.

In this alert display device, the object to be alerted which is in front of the vehicle or around the vehicle and to which the driver needs to be alerted is detected by the detection unit. In the alert display device, when the display image for highlighting the object to be alerted in the actual view in front of the driver of the vehicle or around the vehicle is displayed, the display in which the edge is clear and the display in which the edge is blurred are switched by the display control of the control unit. The display image in which the edge is clear has high visual attraction, and the driver easily keeps the eyes fixed to the display image. The display image in which the edge is blurred has low visual attraction, and the driver rarely keeps the eyes fixed to the display image. Accordingly, the display in which the edge of the display image is clear and the display in which the edge of the display image is blurred are switched, thereby switching between display in which the eyes of the driver are on the display image itself to be highlighted and display in which the eyes of the driver are not on the display image (consequently, display in which the eyes of the driver are on the object to be alerted itself as an object to be highlighted). With this, the display image in which the edge is clear allows the driver to notice the occurrence of the alert (the driver can move the eyes toward the object to be alerted), and the display image in which the edge is blurred allows the driver to notice the object to be alerted itself. As a result, the driver can recognize the object to be alerted itself quickly. In this way, the alert display device switches between the display in which the edge of the display image for highlighting the object to be alerted is clear and the display in which the edge of the display image is blurred, thereby suppressing delay of recognition of the object to be alerted itself.

The actual view is a scene which is actually viewed from the driver in front of the vehicle or around the vehicle. The object to be alerted is an object, to which the driver should pay attention when driving the vehicle, among objects in the actual view in front of the vehicle or around the vehicle, and is an object to which the driver needs to be alerted. Highlighting is display which highlights the object to be alerted in the actual view, and displays the display image for highlighting the object to be alerted. As one display form of highlighting, superimposition display is known. The superimposition display is display in which the display image is positioned conforming to the position of the object to be alerted in the actual view when viewed from the driver. As the display image to be displayed in a superimposing manner, for example, a display image of a frame which is displayed to surround the object to be alerted in the actual view, or a display image of an underscore which is displayed below the object to be alerted in the actual view is used.

In the above-described alert display device, the control unit may perform switching from the display in which the edge of the display image is clear to the display in which the edge of the display image is blurred. First, the display in which the edge of the display image is clear is performed, whereby the driver can keep the eyes fixed to the display image (in particular, the edge) and the driver can move the eyes toward the display image (toward the object to be alerted). Thereafter, the display in which the edge of the display image is blurred, whereby the drive who moves the eyes can keep the eyes fixed to the object to be alerted from the display image to recognize the object to be alerted itself. As a result, the driver can recognize the object to be alerted itself quickly.

The edge is, for example, a portion where brightness is sensitive (for example, luminance is high) compared to the periphery in the display image to be highlighted. For example, in case of an edge of a frame as one type of superimposition display, brightness is sensitive in the end portions (both sides) of each line having a predetermined with constituting the frame. In case of an edge of an underscore as one type of superimposition display, brightness is sensitive in the end portions (both sides) of a bar having a predetermined width as an underscore. The end portions (both sides) are the boundary portions between the display image to be highlighted and the actual view. The display in which the edge is clear is display in which the end portions (both sides) in the display image to be highlighted have sensitive brightness. The display in which the edge is blurred is display in which the end portions (both sides) of a line of the display image to be highlighted have insensitive brightness and the end portions (both sides) are unclear.

In the above-described alert display device, when a given time elapses after the display in which the edge of the display image is clear is performed, the control unit may perform switching to the display in which the edge is blurred. If the eyes of the driver can be on the display image and the eyes of the driver can be moved toward the display image (toward the object to be alerted), thereafter, the display image, on which the eyes of the driver are, is not required. Accordingly, the display image in which the edge is clear is displayed only for the first given time. The given time is the time in consideration of the time necessary for the movement of the eyes of the driver toward the display image when the display image in which the edge is clear is displayed.

In the above-described alert display device, when it is determined that the driver has moved the eyes toward the display image after the display in which the edge of the display image is clear is performed, the control unit may perform switching to the display in which the edge is blurred. As described above, if the eyes of the driver are moved toward the display image, thereafter, the display image, on which the eyes of the driver are, is not required. Accordingly, after the display image in which the edge is clear is displayed, and it is then confirmed that the eyes of the driver are moved toward the display image, switching to the display image in which the edge is blurred is performed.

In the above-described alert display device, the control unit may perform switching from the display in which the edge of the display image is blurred to the display in which the edge of the display image is clear. In this configuration, the display in which the edge of the display image may be first performed, then, the display in which the edge of the display image is blurred may be performed, and thereafter, the display in which the edge of the display image is clear may be performed. In this case, when the driver does not perform a driving operation to avoid the object to be alerted after the display in which the edge of the display image is blurred is performed, or the like, in order to allow the driver to notice the occurrence of the alert, the display in which the edge of the display image is clear is performed again. Alternatively, the display in which the edge of the display image is first blurred is performed, and thereafter, the display in which the edge of the display image is clear may be performed. In this case, for example, the display in which the edge of the display image is blurred is first performed for all detected objects, and switching to the display in which the edge of the display image is performed only for an object, to which the driver needs to be alerted, among the objects.

In the above-described alert display device, the display unit may be a head-up display which is mounted in the vehicle.

According to another aspect of the invention, there is provided an alert display method which highlights an object to be alerted in an actual view in front of a driver of a vehicle or around the vehicle, the method including a detection step of detecting the object to be alerted in front of the vehicle or around the vehicle, a control step of performing display control of a display image for highlighting the object to be alerted detected in the detection step, and a display step of displaying the display image for highlighting the object to be alerted in the actual view in front of the driver of the vehicle or around the vehicle based on the display control in the control step, in which, in the control step, switching control is performed between display in which the edge of the display image is clear and display in which the edge of the display image is blurred.

According to the invention, the display in which the edge of the display image for highlighting the object to be alerted is clear and the display in which the edge of the display image is blurred are switched, thereby suppressing delay of recognition of the object to be alerted itself by highlighting.

### BRIEF DESCRIPTION OF THE DRAWINGS

FIG. 1 is a configuration diagram of an alert display device according to an embodiment.

FIGS. 2A to 2C show an example of superimposition display on a pedestrian, and specifically, FIG. 2A shows a stage in which superimposition display is not performed, FIG. 2B shows an initial stage of superimposition display, and FIG. 2C shows a stage when a given time elapsed after the superimposition display.

FIGS. 3A and 3B show an example of a luminance pattern in a width direction of a line in superimposition display, and specifically, FIG. 3A shows superimposition display in which an edge is clear, and FIG. 3B shows superimposition display in which the edge is blurred.

FIG. 4 is a flowchart showing the flow of alert display according to an embodiment.

### DESCRIPTION OF THE PREFERRED EMBODIMENTS

Hereinafter, an embodiment of an alert display device and an alert display method according to the invention will be described referring to the drawings. In the respective drawings, the same or similar components are represented by the same reference numerals, and overlapping description will be omitted.

In this embodiment, the invention is applied to an alert display device in which a head-up display mounted in a vehicle is used as a display unit. In the head-up display according to this embodiment, in order to allow a driver to recognize an object to be alerted, highlighting in which a display image for highlighting an object to be alerted in an actual view in front of the driver is displayed (in particular, superimposition display in which the display image is positioned conforming to the object to be alerted in the actual view when viewed from the driver) is performed. As the display image which is displayed in the superimposition display, for example, a frame surrounding the object to be alerted or an underscore below the object to be alerted is provided. As the object to be alerted, for example, a pedestrian, a bicycle, a motorcycle, and a vehicle are known. If the alert display device is used when the periphery is dark, for example, at night during which an object to be alerted, such as a pedestrian, is rarely recognized, the effect of an alert can be better exhibited. Accordingly, superimposition display may be performed by the alert display device only when the periphery is dark, for example, at night.

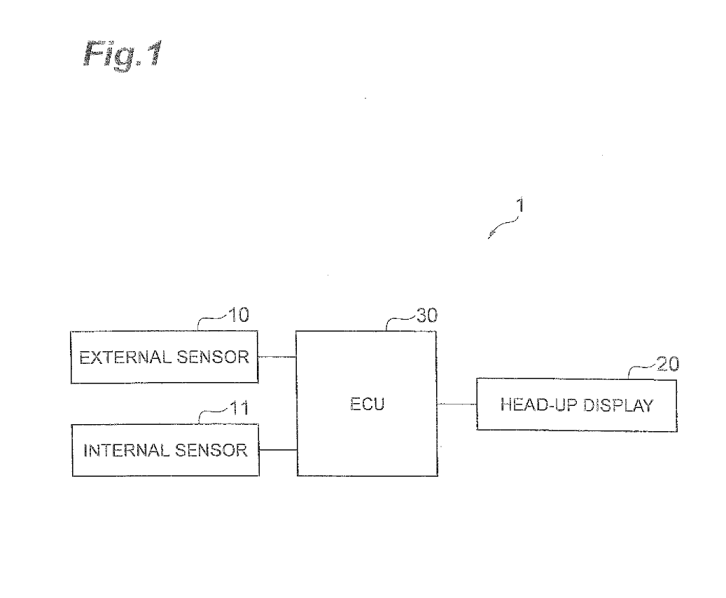

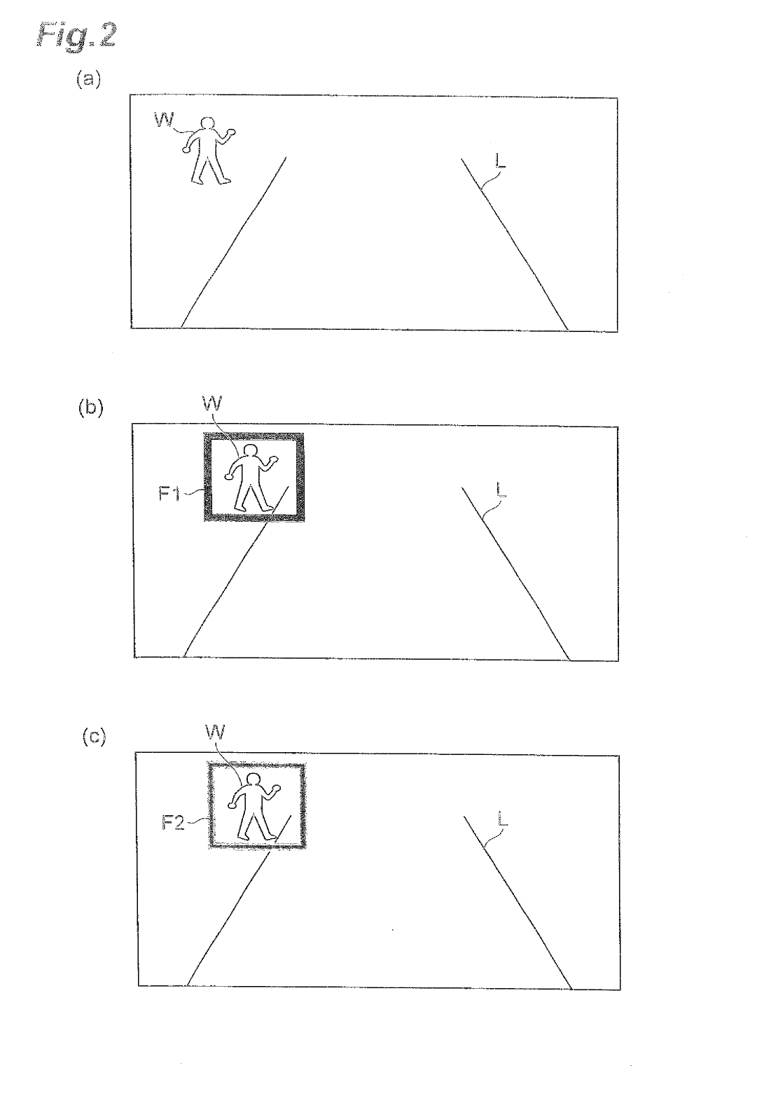

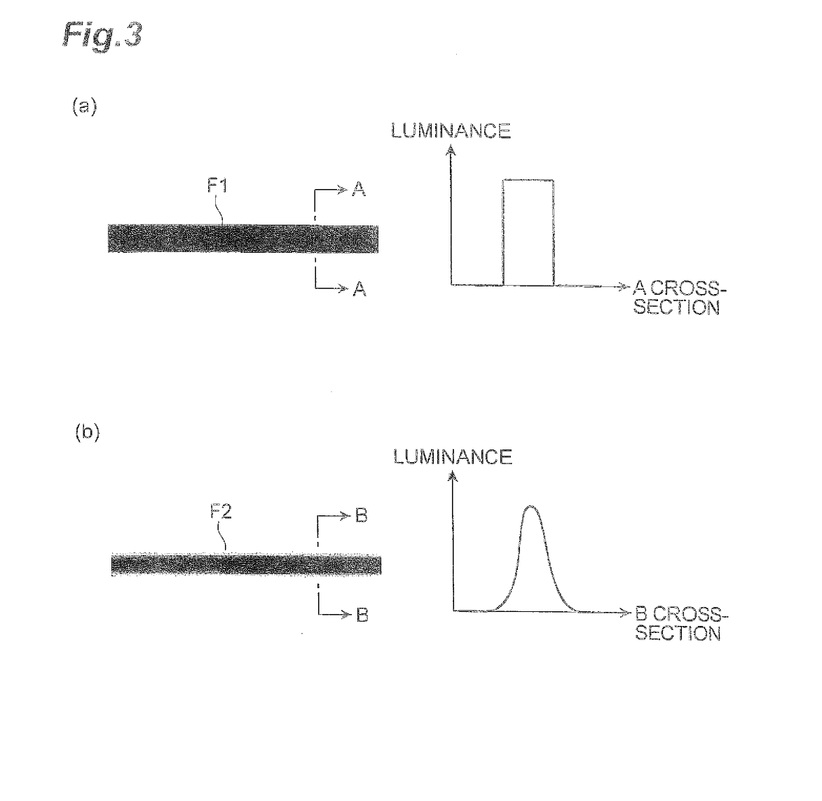

An alert display device 1 according to this embodiment will be described referring to FIGS. 1 to 3B, FIG. 1 is a configuration diagram of the alert display device according to this embodiment. FIGS. 2A to 2C show an example of superimposition display on a pedestrian. FIGS. 3A and 3B show an example of a luminance pattern in a width direction of a line in superimposition display.

In this embodiment, a frame surrounding an object to be alerted will be described as an example of superimposition display. The frame has a rectangular shape. The width of the line of the frame is set to a predetermined width such that visual attraction increases. The color of the line of the frame is set in advance to a color such that visual attraction increases.

In the alert display device, in order to allow the driver to notice the occurrence of the alert for a given time from the start of the superimposition display and to make the driver move the eyes toward the display image (frame) (toward the object to be alerted) displayed in the superimposition display, the display in which the edge in the width direction of the line of the frame in the superimposition display is clear is performed. In order to make the eyes of the driver head toward the object to be alerted itself (in order to make the eyes of the driver not head toward the frame in the superimposition display), the alert display device 1 performs switching to the display, in which the edge in the width direction of the line of the frame in the superimposition display is blurred, when a given time has elapsed.

The alert display device 1 includes an external sensor 10, an internal sensor 11, a head-up display 20, and an Electronic Control Unit (ECU) 30. In this embodiment, the external sensor 10 and the ECU 30 correspond to a detection unit described in the appended claims, the ECU 30 corresponds to a control unit described in the appended claims, and the head-up display 20 corresponds to a display unit described in the appended claims.

The external sensor 10 is a sensor which detects an object (in particular, in front of) outside the vehicle. As the object to be detected, for example, a pedestrian, a bicycle, a motorcycle, and other vehicles are known. As the external sensor 10, for example, a radar sensor, such as a millimeter-wave radar, an ultrasonic radar, or a laser radar, or a camera sensor with a camera and an image processor is provided, or both or one of a radar sensor and a camera sensor may be provided. A known method in the related art is applied to the object detection by the radar sensor or the camera sensor. With the object detection by these sensors, the presence/absence of an object in a three-dimensional space is acquired, and when an object is present, the position (the relative distance from the vehicle, the direction (horizontal position), or the like), size (size in the horizontal direction, the height direction, or the like), type, and the like of the object are acquired. The external sensor 10 detects an object in front of the vehicle in each detection cycle of each sensor to acquire various kinds of information, and transmits an external information signal (information regarding the presence/absence of an object, and when an object is present, information regarding the position, size, type, and the like of each object) to the ECU 30. When a camera is used as a sensor to detect an object even if the periphery is dark, for example, at night, an infrared camera or a near infrared camera is preferably used. When a camera is used as a sensor, a stereo camera which can acquire the distance or the like by parallax is preferably used.

The internal sensor 11 is a sensor which detects information regarding the vehicle. As the internal sensor 11, for example, a GPS [Global Positioning System] sensor (however, when a navigation system is mounted, positional information is acquired from the navigation system) which detects the position of the vehicle, a vehicle speed sensor which detects vehicle speed, a yaw rate sensor which detects a yaw rate, a steering angle sensor which detects a steering angle of a steering wheel, an accelerator pedal sensor which detects an operation amount of an accelerator pedal, and a brake pedal sensor which detects an operation amount of a brake pedal are provided. The internal sensor 11 detects various kinds of information (position, vehicle speed, yaw rate, steering angle, accelerator operation amount, brake operation amount, and the like) regarding the vehicle in each detection cycle of each sensor, and transmits an internal information signal to the ECU 30.

The head-up display 20 is a device which is provided to display video (the frame in the superimposition display or the like) on a front glass to be superimposed on an actual view. In the head-up display 20, video is projected toward the front glass, and video is reflected by the front glass toward the driver, whereby video is formed in front of the front glass to form a virtual image (corresponding to a display image). The head-up display 20 is a known display, and the detailed configuration thereof will be omitted. In the head-up display 20, if a display control signal is received from the ECU 30, information regarding the display position on the front glass or information regarding the frame to be displayed (the size of the frame or the luminance pattern in the width direction of the line of the frame) is acquired from the display control signal, and a frame which is constituted by the line of the luminance pattern designated at the display position designated on the front glass and is of designated size is projected.

The ECU 30 is an electronic control unit which includes a Central Processing Unit (CPU), a Read Only Memory (ROM), a Random Access Memory (RAM), and the like, and performs overall control of the alert display device 1. In the ECU 30, an application program stored in the ROM is loaded on the RAM and executed by the CPU, whereby object-to-be-alerted detection processing, object-to-be-alerted information acquisition processing, display position calculation processing, edge display processing, and blurring display processing are performed. In the ECU 30, the external information signal transmitted from the external sensor 10 is received, and the internal information signal transmitted from the internal sensor 11 is received. In the ECU 30, the above-described processing is performed based on the external information signal or the internal information signal in each control cycle according to the clock frequency of the CPU, and the display control signal is transmitted to the head-up display 20 as necessary.

The object-to-be-alerted detection processing will be described. In the ECU 30, determination is performed about whether or not each object being detected is an object, to which the driver needs to be alerted (which endangers the traveling of the vehicle), using the external information signal from the external sensor 10, and an object which needs to be alerted is determined as an object to be alerted. As the determination method, for example, determination is performed about whether or not the object is moving toward a lane (road) on which the vehicle is traveling, the object is close to the lane, the object is likely to cross the lane, or the like based on the position or the moving direction of the object. At this time, a collision probability between the object and the vehicle is calculated from the position, moving direction, moving speed, or the like of the object and the position, moving direction, moving speed, and the like of the vehicle, and when the collision probability is equal to or greater than a predetermined value, the object may be determined as an object to be alerted. The moving direction or the moving speed of the object can be determined from temporal change in the position of the object. Since the vehicle and the object are moving (however, may be stopped), and thus, the positional relationship between the vehicle and the object changes temporally, it is necessary to perform the determination in each control cycle even for the same object.

In the example shown in FIGS. 2A to 2C, a pedestrian W is detected as an object by the external sensor 10, and the vehicle is traveling on a lane (road) L. In the stage shown in FIG. 2A, since the pedestrian W is moving toward the lane L but is separated from the lane L, the pedestrian W is determined as an object not to be alerted. For the pedestrian W at this time, superimposition display is not performed. On the other hand, in the stages shown in FIGS. 2B and 2C, since the pedestrian W approaches the lane L and is likely to cross the lane L, the pedestrian W is determined as an object to be alerted. For the pedestrian W at this time, superimposition display is performed to alert the driver. In FIG. 2A, only an actual view is shown, and in FIGS. 2B and 2C, superimposition display is performed on the actual view.

The object-to-be-alerted information processing will be described. In the ECU 30, information regarding to the position, size, type, and the like of the object is extracted from the external information signal from the external sensor 10 for each object, which is determined as an object to be alerted. Since the vehicle and the object are moving, and thus, the relative position or size of the object from the vehicle changes temporally, it is necessary to acquire information in each control cycle even for the same object.

The display position calculation processing will be described. In the ECU 30, the position of the frame or the size of the frame to be displayed on the head-up display 20 is calculated based on the acquired position and size of the object for each object, which is determined as an object to be alerted, Here, the position projected onto the front glass or the size of the frame is calculated taking into consideration the eye point (the position of the eye) of the driver such that the superimposed frame surrounds the object to be alerted in the actual view when viewed from the driver. In regards to the calculation method, a known calculation method in the related art is applied. Since the vehicle and the object are moving, and thus, the relative position or size of the object from the vehicle changes temporally, it is necessary to calculate the position or size of the frame in each control cycle.

The edge display processing will be described. In the ECU 30, a display control signal for edge display is generated for each object, which is determined as an object to be alerted, and the display control signal is transmitted to the head-up display 20. The display control signal includes information regarding the calculated position and size of the frame at the time of the display on the head-up display 20. In particular, the display control signal for edge display includes a luminance pattern which has a given luminance value in the width direction of the line of the frame. As the given luminance value, a high luminance value (for example, the highest luminance value within the luminance range) within a luminance range to be displayed on the head-up display 20 is set in advance such that the edge in the width direction of the line of the frame is clear. In the ECU 30, the display control signal for edge display is transmitted to the head-up display 20 for a given time from the start of the display. The given time is the time taking into consideration the time necessary for the eyes of the driver to move toward the superimposed frame when a frame in which the edge of each line constituting the frame is clear, and is set in advance by an experiment or the like. As the given time, for example, the time less than 1 second is set. Since the position or size of the frame to be displayed is computed in each control cycle, it is necessary to generate the display control signal in each control cycle accordingly.

In the example shown in FIG. 2B, since the pedestrian W becomes an object to be alerted, superimposition display is performed such that a frame F 1 surrounds the pedestrian W when viewed from the driver. FIG. 3A shows a part of the line of the frame F1 of FIG. 2B and a luminance pattern, and in the luminance pattern, luminance has a given high value in the width direction (A cross-section) of the line. For this reason, the edge in the width direction of each line constituting the frame F1 is clear. With this edge, the frame F1 has very high visual attraction. While the frame F1 shown in FIG. 2B in which the edge is clear is displayed in a superimposing manner for a given time, the driver is attracted to the sharp edge of the superimposed frame F1, moves the eyes toward the frame F1 (consequently, toward the pedestrian W) instantaneously, and focuses on the frame F1 (in particular, the edge).

The blurring display processing will be described. In the ECU 30, if the given time of the superimposition display by the display control signal for edge display elapses for each object, which is determined as an object to be alerted, a display control signal for blurring display is generated, and the display control signal is transmitted to the head-up display 20. The display control signal includes information regarding the position and size of a frame for display. In particular, the display control signal for blurring display includes a luminance pattern in which a luminance value decreases from the center portion to the respective end portions (both sides) in the width direction of the line of the frame. Change in the decreasing luminance value may decrease linearly or may decrease in a curve shape, like a normal distribution curve. The highest luminance value in the center portion may be the same luminance value as the given luminance value for edge display or a luminance value around the given luminance value. The smallest luminance value of each edge may be 0 or a value smaller than 0. In this way, the luminance value decreases in the end portions (both sides), whereby the edge of the line of the frame is in a blurred state. In the ECU 30, the display control signal for blurring display is transmitted to the head-up display 20 until an object is determined as an object not to be alerted.

In the example shown in FIG. 2C, when the given time has elapsed after the frame F 1 of FIG. 2B in which the edge is clear is displayed in a superimposing manner, superimposition display is performed such that a frame F2 surrounds the pedestrian W when viewed from the driver. FIG. 3B shows a part of the line of the frame F2 of FIG. 2C and a luminance pattern, and in the luminance pattern, luminance in the width direction (B cross-section) of the line is highest in the center portion and decreases to 0 at the edge in a normal distribution curve shape. For this reason, the edge in the width direction of each line constituting the frame F2 is in a blurred state. With the blurring of the edge, the frame F2 has low visual attraction. When the frame F2 shown in FIG. 2C in which the edge is blurred is displayed in a superimposing manner, the driver is not attracted to the frame F2 displayed in a superimposing manner, focuses on the pedestrian W in the frame, and recognizes the pedestrian W. In the example shown in FIG. 3B, although change in luminance has a normal distribution curve shape, for example, a triangular shape, or a trapezoidal shape in which the luminance value of the center portion is constant by a predetermined width is provided.

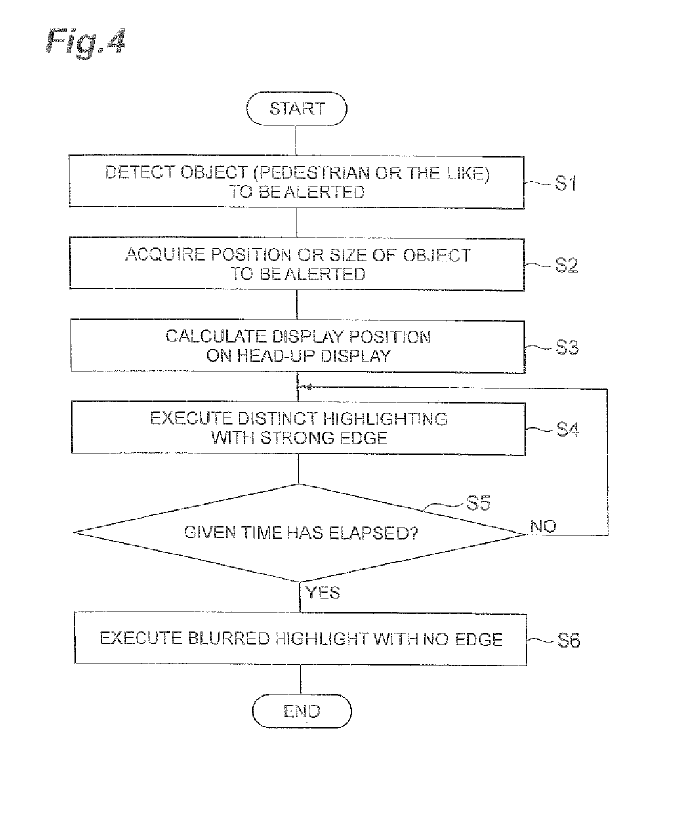

The flow of the operation of the alert display device 1 having the above-described configuration will be described referring to the flowchart of FIG. 4. FIG. 4 is a flowchart showing the flow of alert display according to this embodiment.

The external sensor 10 detects an object in front of the vehicle in each detection cycle, when an object can be detected, acquires these kinds of information regarding the position, size, type, and the like of the object, and transmits information as an external information signal to the ECU 30. The ECU 30 receives the external information signal and temporarily stores information included in the external information signal. The internal sensor 11 detects the position, speed, yaw rate, steering angle, accelerator operation amount, brake operation amount, and the like of the vehicle in each detection cycle, and transmits the detected information as an internal information signal to the ECU 30. The ECU 30 receives the internal information signal and temporarily stores information included in the internal information signal.

The ECU 30 performs determination about whether or not each object being detected is an object, to which the driver needs to be alerted, based on information included in the external information signal in each control cycle, and detects an object, which needs to be alerted, as an object to be alerted (S1). S1 corresponds to a detection step described in the appended claims. The ECU 30 acquires information regarding the position, size, type, and the like of the object to be alerted based on information included in the external information signal for the detected object to be alerted (S2).

The ECU 30 calculates the position or size of the frame at the time of the display on the head-up display 20 based on the acquired position and size for each detected object to be alerted in each control cycle (S3).

The ECU 30 generates a display control signal for edge display for displaying a frame, in which the edge in the width direction of the line is clear, in a superimposing manner for each detected object to be alerted in each control cycle, and transmits the display control signal to the head-up display 20 (S4). If the display control signal is received, the head-up display 20 projects video of a frame, which is of size represented by the display control signal and has a line having a given high luminance value in the width direction represented by the display control signal, on the front glass at the display position represented by the display control signal (S4). If the projected frame is reflected by the front glass toward the driver, the frame surrounding the object to be alerted is imaged in front of the front glass, and the object to be alerted is highlighted by the frame. In particular, since the frame has a distinct line with a sharp edge, the driver instantaneously keeps the eyes fixed to the frame (in particular, the edge). Then, the driver moves the eyes toward the frame and notices the occurrence of the alert. At this time, the driver focuses on the frame (in particular, the edge).

The ECU 30 performs determination about whether or not a given time has elapsed from the start of the superimposition display of the frame for each detected object to be alerted in each control cycle (S5). If it is determined in S5 that the given time has not elapsed, the ECU 30 generates the display control signal for edge display in the same manner as described above for the object to be alerted, and transmits the display control signal to the head-up display 20 (S4). If the display control signal is received, the head-up display 20 projects video of the frame onto the front glass in the same manner as described above (S4).

If it is determined in S5 that the given time has elapsed, the ECU 30 generates a display control signal for edge display for displaying a frame, in which the edge in the width direction of the line is blurred, in a superimposing manner for the object to be alerted, and transmits the display control signal to the head-up display 20 (S6). If the display control signal is received, the head-up display 20 projects video of a frame, which is of size represented by the display control signal and has a line with a decreasing luminance value from the center portion to the edge in the width direction represented by the display control signal, on the front glass at the display position represented by the display control signal (S6). With this projection, the frame surrounding the object to be alerted is imaged in front of the front glass in the same manner as described above, and the object to be alerted is highlighted by the frame. In particular, since the frame is a frame which has a line blurred from the center portion to the edge, the driver does not keep the eyes fixed to the frame. For this reason, the driver who faces the frame focuses on the object to be alerted in the frame and recognizes the object to be alerted. If necessary, the driver performs a driving operation to avoid the object to be alerted. S3, S4, and S6 correspond to a control step described in the appended claims. S4 and S6 correspond to a display step described in the appended claims.

If an object which has been detected as an object to be alerted is not detected as an object to be alerted, the ECU 30 stops the transmission of the display control signal for the object to be alerted. Accordingly, the head-up display 20 stops the projection of video of the frame surrounding the object to be alerted.

According to the alert display device 1, switching is performed from the display in which the edge of the display image displayed in the superimposition display (highlighting) is clear to the display in which the edge is blurred, whereby it is possible to suppress delay of recognition of the object to be alerted itself by the superimposition display. That is, in the initial stage of the alert by the superimposition display, with the superimposition display (display having high visual attraction) in which the edge of the display image is clear, even if the driver is looking in a different direction, it is possible to allow the driver to notice the occurrence of the alert and to make the eyes of the driver move toward the display image (toward the object to be alerted). In particular, the display in which the edge of the display image is clear is performed, whereby the eyes of the driver are promoted to head toward the display image itself in the initial stage. Then, after the given time has elapsed, with the superimposition display (display having low visual attraction) in which the edge of the display image is blurred, it is possible to allow the driver, who faces the display image, to notice the object to be alerted itself while highlighting the object to be alerted with the display image. In particular, the display in which the edge of the display image is blurred is performed, whereby it is possible to prevent the eyes of the driver from not heading toward the object to be alerted itself.

According to the alert display device 1, since the switching from the superimposition display in which the edge of the display image is clear and the superimposition display in which the edge is blurred is determined according to the length of the time, separate equipment which performs determination about whether or not the driver actually faces the display image is not required. According to the alert display device 1, with a simple method of blurring display in which only luminance is changed, it is possible to lower visual attraction on the display image and to allow quick recognition of the object to be alerted itself.

Although the embodiment of the invention has been described, the invention is not limited to the above-described embodiment and may be carried out in various forms.

For example, in this embodiment, although the invention is applied to a head-up display which is mounted in a vehicle, the invention may be applied to a display device which is brought in the vehicle from the outside, or a display device, such as a night view system, which displays an actual view imaged by a camera and highlights an object to be alerted in the actual view. In this embodiment, although a configuration in which an object to be alerted in an actual view in front of a vehicle is highlighted has been made, a configuration in which an object to be alerted in an actual view around the vehicle, such as a rear side or a lateral side, is highlighted may be made.

In this embodiment, although a configuration in which the superimposition display in which, as highlighting, a display image is positioned and displayed conforming to the position of an object to be alerted by a frame surrounding the object to be alerted has been made, a configuration in which a different kind of highlighting than superimposition display is performed may be made. As highlighting other than the superimposition display, for example, highlighting in which arrows in multiple directions (eight directions at intervals of equal angle, or the like) are displayed as display images at a prescribed display position (the position in the direction of the eyes of the driver during normal driving) is provided, and when an object to be alerted is detected, a display image of an arrow in a direction closest to the direction of the object to be alerted is displayed. Even when highlighting is performed using the display image of the arrow, display in which the edge of the arrow is clear is performed, whereby the driver keeps the eyes fixed to the arrow to make the eyes of the driver turn toward the arrow itself, and the driver recognizes the direction indicated by the arrow. Thereafter, display in which the edge of the arrow is blurred is performed, the driver turns the eyes in the direction (that is, toward the object to be alerted) indicated by the arrow from the arrow itself, thereby allowing the driver to recognize the object to be alerted itself. As a result, the driver can quickly recognize the object to be alerted itself.

In this embodiment, although a configuration in which switching to highlighting by a display image with a blurred edge is performed when a given time has elapsed after highlighting by a display image with a clear edge starts has been made, a configuration in which the direction of the eyes of the driver is detected, and when it is determined that the eyes of the driver are on the display image with a clear image (on the object to be alerted), switching to highlighting by the display image with a blurred edge is performed may be made, or a configuration in which a driving operation (brake operation, accelerator operation, steering operation) of the driver is detected, and when it is determined that the driver performs an operation to avoid the object to be alerted, switching to highlighting by the display image with a blurred edge is performed may be made.

In this embodiment, although a configuration in which switching is performed from highlighting by a display image with a clear edge to highlighting by a display image with a blurred edge has been made, a configuration in which, when it is determined that the driver does not perform an operation to avoid an object to be alerted after switching to highlighting by a display image with a blurred edge, switching to highlighting by a display image with a clear edge is performed again may be made, or a configuration in which highlighting by a display image with a blurred edge is first performed and then switched to highlighting by a display image with a clear edge may be made. For example, highlighting by a display image with a blurred edge is first performed for all detected objects and then switched to highlighting by a display image with a clear edge only for an object, which needs to be alerted, among the objects.

What is claimed is:

1. An alert display device which highlights an object to be alerted in an actual view in front of a driver of a vehicle or around the vehicle, the device comprising:
a detection unit configured to detect the object to be alerted in front of the vehicle or around the vehicle;
a control unit configured to perform display control of a display image for highlighting the object to be alerted detected by the detection unit; and
a display unit configured to display the display image for highlighting the object to be alerted detected by the detection unit in the actual view in front of the driver of the vehicle or around the vehicle based on the display control of the control unit,
wherein the control unit performs switching control for switching between display in which the edge of the display image is clear and display in which the edge of the display image is blurred.

2. The alert display device according to claim 1,
wherein the control unit performs switching from the display in which the edge of the display image is clear to the display in which the edge is blurred.

3. The alert display device according to claim 2,
wherein, when a given time elapses after the display in which the edge of the display image is clear is performed, the control unit performs switching to the display in which the edge is blurred.

4. The alert display device according to claim 2,
wherein, when it is determined that the driver has moved the eyes toward the display image after the display in which the edge of the display image is clear is performed, the control unit performs switching to the display in which the edge is blurred.

5. The alert display device according to claim 1,
wherein the control unit performs switching from the display in which the edge of the display image is blurred to the display in which the edge of the display image is clear.

6. The alert display device according to claim 1,
wherein the display unit is a head-up display which is mounted in the vehicle.

7. An alert display method which highlights an object to be alerted in an actual view in front of a driver of a vehicle or around the vehicle, the method comprising:
a detection step of detecting the object to be alerted in front of the vehicle or around the vehicle;
a control step of performing display control of a display image for highlighting the object to be alerted detected in the detection step; and
a display step of displaying the display image for highlighting the object to be alerted in the actual view in front of the driver of the vehicle or around the vehicle based on the display control in the control step,
wherein, in the control step, switching control is performed between display in which the edge of the display image is clear and display in which the edge of the display image is blurred.
